(19) United States
(12) Patent Application Publication
(10) Pub. No.: US 2013/0247004 A1
(43) Pub. Date: Sep. 19, 2013

(54) VISUALLY INDICATING FILE ALLOCATION IN AN INTEGRATED DEVELOPMENT ENVIRONMENT

(71) Applicants: Lisa Seacat DeLuca, San Francisco, CA (US); Bianca Xue Jing, Littleton, MA (US); Asima Silva, Westford, MA (US)

(72) Inventors: Lisa Seacat DeLuca, San Francisco, CA (US); Bianca Xue Jing, Littleton, MA (US); Asima Silva, Westford, MA (US)

(73) Assignee: INTERNATIONAL BUSINESS MACHINES CORPORATION, ARMONK, NY (US)

(21) Appl. No.: 13/423,475

(22) Filed: Mar. 19, 2012

(51) Int. Cl. G06F 9/44; G06F 15/16

(52) U.S. Cl. 717/120

(57) ABSTRACT

In a method for allocating a file to a user, a first computer receives, over a network, data monitored by a second computer. The first computer comprises an IDE client. The data comprises data of usage of the file by one or more users in a group of users. The first computer receives a request to allocate the file to a first user in the group. In response to the first computer determining that, based on the data of usage, the file is allocated to a second user in the group, the first computer denies the request. The first computer adds the first user to an end of a queue identifying one or more users in the group that are waiting for the second user to relinquish allocation of the file. The first computer utilizes the data of usage to display the queue in the IDE client.

### TECHNICAL FIELD

The present invention relates generally to collaborative software development and more specifically to visually indicating file allocations in integrated software development environments.

### BACKGROUND

There are many tools to help a software developer develop computer program source code. One standard tool is an integrated development environment (IDE), which provides the developer with a programming environment. Typically, the IDE includes an editor for writing code, a compiler or an interpreter, a code search engine, tools for tracing the operation of the code, tools for selecting objects defined in the code, tools for selecting files, and the like. IDEs that are used for developing object-oriented software may also include a class browser, an object inspector, and a class hierarchy diagram.

One example of an IDE that may be used to develop object-oriented software is Eclipse™, available from the Eclipse Foundation, Inc. of Ottawa, Ontario, Canada (Eclipse is a trademark of The Eclipse Foundation in the United States, other Countries, or both). Eclipse is an open source Java® IDE and provides a platform-independent software framework and a set of services for building a development environment from plug-in components (Java is a trademark or registered trademark of Oracle and/or its affiliates). Eclipse includes a standard set of plug-ins, including the Java Development Tools (JDT) and the Plug-in Development Environment (PDE), that enable developers to extend Eclipse and build tools that can be integrated seamlessly with the Eclipse environment. In Eclipse, an IDE project is represented and defined by a collection of project files and project information.

Version control systems (VCSs) are commonly used in today's software development environments. A VCS tracks differences in source code files as well as other file-oriented metrics resulting from multi-user editing of the same source code file. Further, the modern VCS permits access to any of a family of versions of the same source code file. The modern VCS accepts, by way of example, requests to access a version of a source code file that is common to at least two different users, a merged version of at least two different versions of a source code file produced by at least two different users, a latest or newer version of a source code file, an older ancestral version of a source code file that is common to at least two different users, and the like.

### SUMMARY

In one aspect, a method for allocating a file to a user is provided. The method comprises a first computer receiving, over a network, data monitored by a second computer. The first computer comprises an integrated development environment (IDE) client. The data monitored by the second computer comprises data of usage of the file by one or more users in a group of users. The method further comprises the first computer receiving a request to allocate the file to a first user in the group. The method further comprises, in response to the first computer receiving the request, the first computer determining, based on the data of usage of the file, whether the file is allocated to a second user in the group. The method further comprises, in response to the first computer determining that the file is allocated to the second user in the group, the first computer denying the request. The method further comprises the first computer adding the first user to an end of a queue identifying one or more users in the group that are waiting for the second user to relinquish allocation of the file. The method further comprises the first computer utilizing the data of usage of the file to display the queue in the IDE client.

In another aspect, a computer program product for allocating a file to a user is provided. The computer program product comprises one or more computer-readable tangible storage devices and a plurality of program instructions stored on at least one of the one or more computer-readable tangible storage devices for execution by at least one of one or more processors. The plurality of program instructions comprises program instructions to receive, over a network, data monitored by a computer. The data comprises data of usage of the file by one or more users in a group of users. The plurality of program instructions further comprises program instructions to receive a request to allocate the file to a first user in the group. The plurality of program instructions further comprises program instructions to, in response to receiving the request, determine, based on the data of usage of the file, whether the file is allocated to a second user in the group. The plurality of program instructions further comprises program instructions to, in response to determining that the file is allocated to the second user in the group, deny the request. The plurality of program instructions further comprises program instructions to add the first user to an end of a queue identifying one or more users in the group that are waiting for the second user to relinquish allocation of the file. The plurality of program instructions further comprises program instructions to utilize the data of usage of the file to display the queue in an IDE client.

In another aspect, a computer system for allocating a file to a user is provided. The computer system comprises one or more processors, one or more computer-readable tangible storage devices, and a plurality of program instructions stored on at least one of the one or more storage devices for execution by at least one of the one or more processors. The plurality of program instructions comprises program instructions to receive, over a network, data monitored by a second computer system. The data comprises data of usage of the file by one or more users in a group of users. The plurality of program instructions further comprises program instructions to receive a request to allocate the file to a first user in the group. The plurality of program instructions further comprises program instructions to, in response to receiving the request, determine, based on the data of usage of the file, whether the file is allocated to a second user in the group. The plurality of program instructions further comprises program instructions to, in response to determining that the file is allocated to the second user in the group, deny the request. The plurality of program instructions further comprises program instructions to add the first user to an end of a queue identifying one or more users in the group that are waiting for the second user to relinquish allocation of the file. The plurality of program instructions further comprises program instructions to utilize the data of usage of the file to display the queue in an IDE client.

### BRIEF DESCRIPTION OF THE SEVERAL VIEWS OF THE DRAWINGS

FIG. 1 is an illustration of a software development environment for allocating a file to a user for editing in accordance with one embodiment of the present invention.

FIG. 2 illustrates a data flow diagram of a process for allocating a file to a user for editing in a software development environment, according to one embodiment of the present invention.

FIG. 3 illustrates in more detail steps performed by a collaboration program for allocating a file to a user for editing in a software development environment, according to one embodiment of the present invention.

FIG. 4 is a block diagram of internal and external components of each of the computers of FIG. 1.

### DETAILED DESCRIPTION

Embodiments of the present invention recognize that, typically a group of software developers write and edit computer program source code files of a software development project. Embodiments of the present invention further recognize that, in such cases, a first developer in the group can use an IDE to allocate a source code file in the project to the developer so that the first developer can edit the source code file. Embodiments of the present invention further recognize that, if a second developer wants to edit the source code file, the second developer typically must resort to a manual method to determine whether another developer in the group has already been allocated the file for editing. For example, the second developer may need to ask all of the other developers in the group whether they have been allocated the file.

The illustrative embodiments used to describe the invention generally address and solve the above-described problems and other problems related to source code development using an IDE. Generally, an embodiment provides software developers in the group with visual information, within an IDE, regarding allocation of the file.

Embodiments of the present invention will now be described with reference to the figures. Various embodiments of the present invention may be implemented generally within any client/server computing environment suited for allowing multiple developers to develop software applications. More specifically, embodiments of the present invention may be implemented in a document management system or a system where one or more developers are working on files that are interrelated. For example, embodiments of the present invention may supplement or be implemented within an IDE. While some embodiments of the present invention are described with reference to the Eclipse open-source platform IDE, it should be appreciated that such embodiments are exemplary and are not intended to imply any limitation with regard to the environments or IDE platforms in which different embodiments may be implemented.

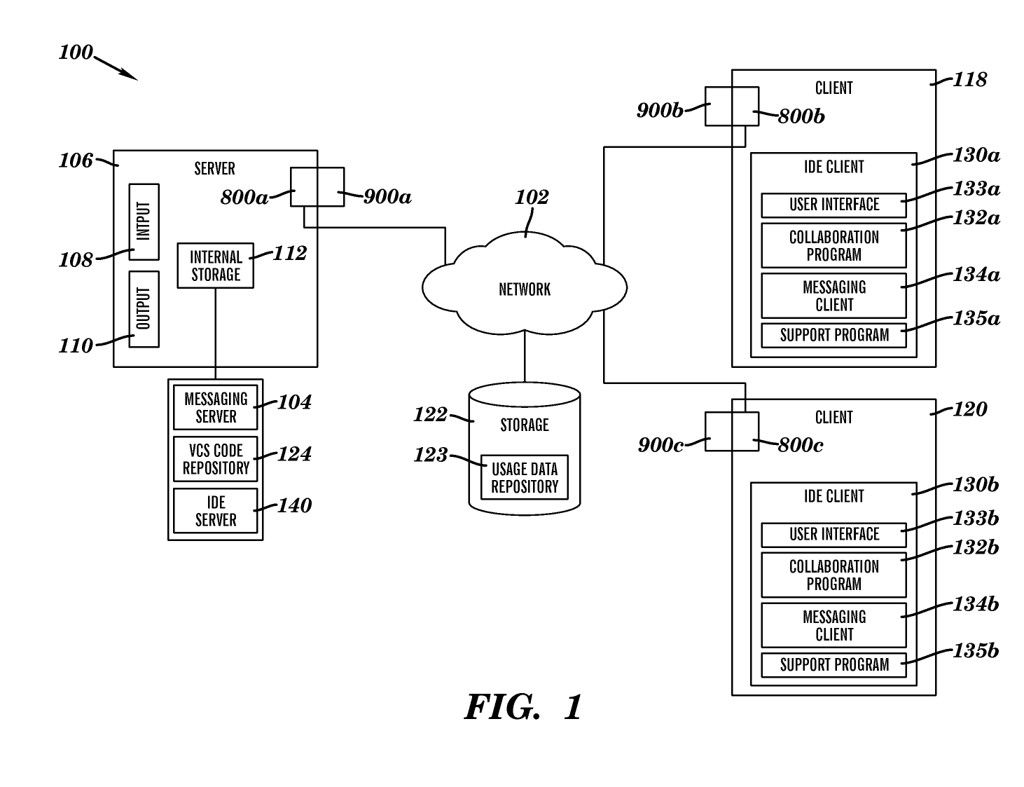

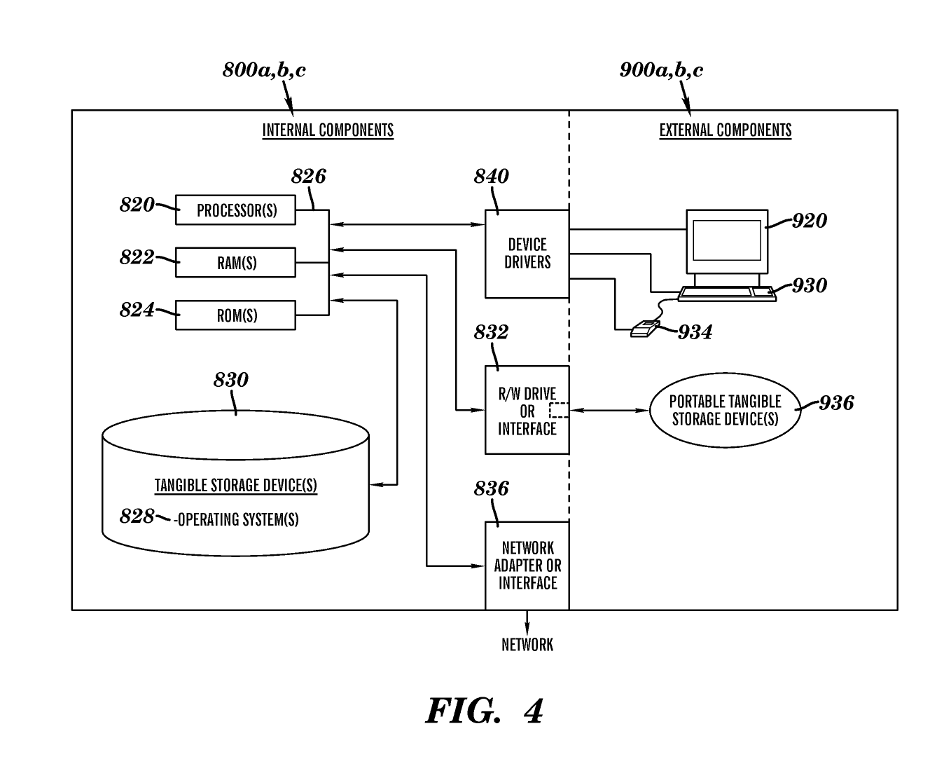

FIG. 1 is an illustration of a software development environment for allocating a file to a user for editing in accordance with one embodiment of the present invention. FIG. 1 is intended as an exemplary embodiment, not as an architectural limitation for different embodiments of the present invention, and therefore, the particular elements shown in FIG. 1 should not be considered limiting with regard to the environments in which the illustrative embodiments of the present invention may be implemented. Software development environment 100 includes client computers 118 and 120 coupled to a server computer 106 and storage unit 122 via a network 102 such as the Internet. As will be discussed with reference to FIG. 4, server computer 106 includes internal components 800a and external components 900a, client computer 118 includes internal components 800b and external components 900b, and client computer 120 includes internal components 800c and external components 900c. For simplicity purposes, only two client computers 118 and 120 are shown in FIG. 1, although in other embodiments, software development environment 100 can include additional client computers. Network 102 represents a worldwide collection of networks and gateways that use the Transmission Control Protocol/Internet Protocol suite of protocols to communicate with one another. At the heart of the Internet is a backbone of high-speed data communication lines between major nodes or host computers consisting of thousands of commercial, governmental, educational and other computer systems that route data and messages. Alternatively, the computers and other devices of software development environment 100 may be interconnected by different types of networks, such as an intranet, a local area network (LAN), or a wide area network (WAN). Network 102 may include communication connections, such as wire, wireless communication links, or fiber optic cables.

Client computers 118 and 120 may be, for example, mobile devices, telephones, personal digital assistants, netbooks, laptop computers, tablet computers, desktop computers, or any type of computing devices capable of hosting an IDE client. According to various embodiments of the present invention, an IDE with collaborative functionality may provide a group of software developers the ability to collaborate in real-time about the computer program source code they may be developing, rather than in a meeting. The term “collaborate”, as used herein, refers to communicating electronically with another person. Such communicating might take place by email, instant messaging or any other appropriate form. In various embodiments, the IDE may be implemented as a client/server program, in which a portion of the IDE, IDE server 140, is provided on server computer 106, and other portions, IDE clients 130a-b are provided on client computers 118 and 120, respectively. Software developers in the group typically will directly interact with IDE clients 130a-b.

Server computer 106 may also include a VCS code repository 124. IDE server 140 is communicatively coupled to VCS code repository 124 to read project files of a project from VCS code repository 124. The project files may be source code files having any variety of formats such as, for example, C++ or Java source code or HTML text. VCS code repository 124 contains a copy of the project.

Client computers 118 and 120 include IDE client 130a and 130b, respectively. In one embodiment, IDE clients 130a-b may include modified versions of the Eclipse IDE. IDE clients 130a-b manage local copies of the project files and other items within the project. When a project is initially accessed by a developer in the group, IDE client 130a-b typically creates, on client computers 118 and 120, respectively, a local directory structure which minors that of the project files stored in VCS code repository 124 on server computer 106.

IDE clients 130a-b include user interfaces 133a-b, respectively. Typically, user interfaces 133a-b are graphical user interfaces that provide the user with access to some or all of the functions of the IDE. The terms “user” and “developer” are used interchangeably herein. Typically, user interfaces 133a-b display information via a display device 920 of external components 900b (shown in FIG. 4) and a display device 920 of external components 900c (shown in FIG. 4), respectively, such as a monitor, a laptop screen, television, or the like, and receive input from the user (as described below, for example) via one or more input devices of external components 900b and 900c, respectively, which can include, without limitation, a keyboard 930, a mouse 934, a trackball, a digitizing tablet, or the like.

IDE clients 130a-b and IDE server 140 may be communicatively coupled to a usage data repository 123. Usage data repository 123 can hold one or more types of usage data. Exemplary types of usage data will be discussed below. Usage data repository 123 may be kept in storage unit 122, as shown, or alternatively in internal storage 112 of server computer 106. In some embodiments, storage unit 122 may be a data repository in a cloud computing environment.

According to an exemplary embodiment of the present invention, IDE clients 130a-b may each include a messaging client 134a-b, respectively, configured for exchanging messages with one another and with messaging server 104 via network 102. By way of example, messaging server 104 may deliver messages using one or more methods, such as, but not limited to instant messaging, email, bulletin boards, social networking sites and other messaging services. Messaging server 104 may be, for example, any suitable instant messaging server, such as a Lotus® Sametime® Connect server, commercially available from International Business Machines Corporation (IBM) of Armonk, N.Y.

In addition, IDE clients 130a-b may include a collaboration program 132a-b, respectively. In one embodiment, collaboration programs 132a-b, user interfaces 133a-b and messaging clients 134a-b are integrated within IDE clients 130a-b, respectively, and may enable a developer to view, via the IDE, information associated with project files, such as, for example, how many other users might be waiting for a specific project file to become available for editing. In addition, collaboration programs 132a-b enable users to initiate communication with a current user of the file from within the IDE. In an embodiment, collaboration programs 132a-b may be implemented as a plug-in component for an IDE and may be downloaded to client computers 118 and 120, respectively, from internal storage 112 of server computer 106. In such embodiment, collaboration programs 132a-b may include instructions executable by client computer 118 and 120, respectively, to display, in a collaborative IDE environment usage data for a project file in the project.

IDE clients 130a-b may be configured to monitor and collect the usage data for the project file. In an embodiment, usage data collection and management functionality may be provided by support programs 135a-b that may be integrated with collaboration programs 132a-b, respectively, within IDE clients 130a-b, respectively. In an embodiment, support programs 135a-b may include, for example, Rational Team Concert™, commercially available from IBM of Armonk, N.Y., although support programs 135a-b may instead include alternate programs in other embodiments. In one embodiment, support programs 135a-b may also be configured to repeatedly retrieve usage data from usage data repository 123 after a predetermined period of time.

The usage data for the project file may include data of usage of the project file by users in the group. For example, the usage data for the project file may include data of user interactions by one or more users in the group with the project file via an IDE client, such as user interactions with IDE client 130a and/or 130b, to open, close, lock, or save the project file. In an embodiment, IDE clients 130a-b may track the user interactions. In an embodiment, the usage data for the project file may also include user attributes associated with a user in the group currently editing the project file. The user attributes may include, for example, the name of the user currently editing the project file, a digital image of the user, contact information of the user, an instant messaging status of the user, an editing activity of the user on the file, or the like. In an embodiment, IDE clients 130a-b send the usage data to IDE server 140. IDE server 140 processes the received usage data and stores the received usage data in usage data repository 123.

In the illustrated example, data is communicated between server computer 106 and client computers 118 and 120 using a standard protocol such as Hyper Text Transfer Protocol (HTTP), File Transfer Protocol (FTP), Simple Object Access Protocol (SOAP) over HTTP, or the like. Software development environment 100 may include additional server computers, client computers, displays and other devices not shown. Client computers 118 and 120 are clients to server computer 106 in this example. Server computer 106 may contain an input device 108 and an output device 110.

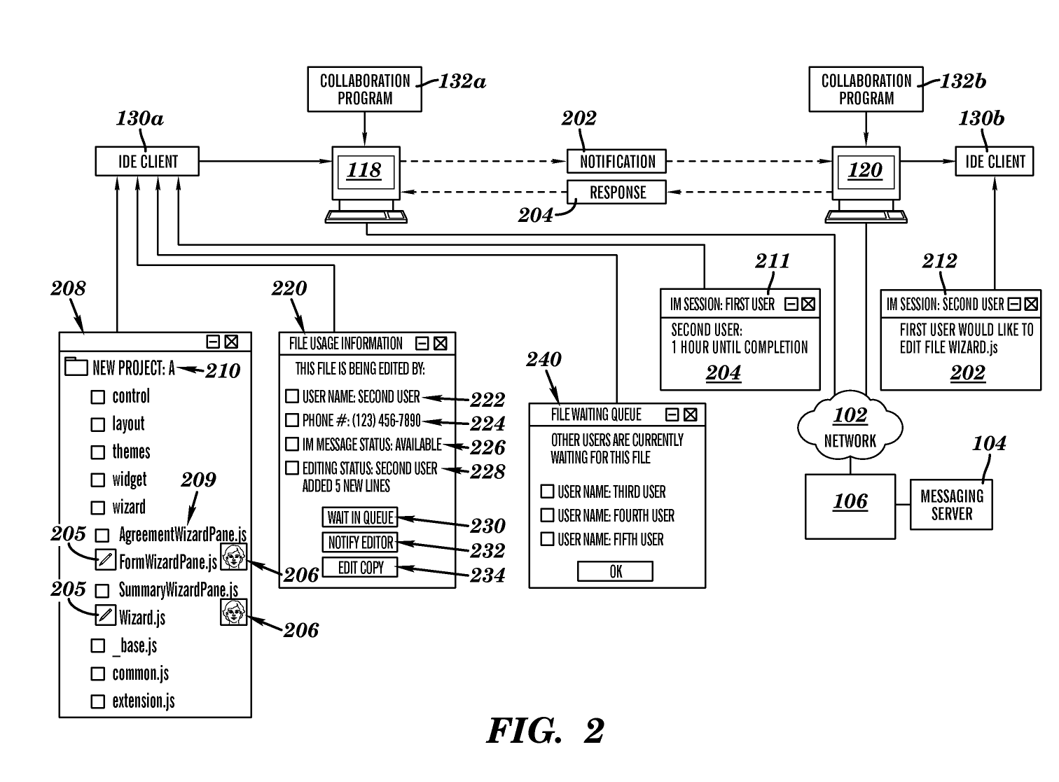

FIG. 2 illustrates a data flow diagram of a process for allocating a file to a user for editing in a software development environment, according to one embodiment of the present invention. User interface 133a of IDE client 130a contains a project window 208 which lists the directory structure of the project files for a project. Project window 208 can be implemented similarly to the Package Explorer in the Eclipse platform. Project window 208 identifies a project and lists the project files associated with that project. The project itself is identified by a project name 210. Each project file within the project is identified by a file name, e.g., file name 209. As illustrated in FIG. 2, project window 208 may further include one or more icons 205 displayed next to file names. In one embodiment, icons 205 may indicate that a file is currently being edited.

Collaboration program 132a displays usage data of in the form of icons 205 corresponding to files listed in project window 208 (e.g., to indicate that the corresponding files are being edited). In the embodiment depicted in FIG. 2, collaboration program 132a displays usage data (for example, images 206) identifying users currently editing corresponding files listed in project window 208. In various embodiments, collaboration program 132a may employ various icons or symbols to visually display other types of usage data of corresponding files listed in project window 208. Collaboration program 132a updates displayed usage data based on additional usage data retrieved by support program 135a.

A first user in a group of users working on the project may be interested in editing one of the project files within the project. Collaboration program 132a is capable of detecting users' file allocation requests. In one embodiment, the first user may request an allocation of a project file by clicking on file name 209 in project window 208. In response to receiving the first user's allocation request, collaboration program 132a determines, based on usage data for the project file, whether the project file is locked by a second user in the group. In an embodiment, in response to determining that the project file is not locked by a second user in the group, collaboration program 132a retrieves a latest version of the project file from VCS code repository 124 on server computer 106, stores the retrieved latest version of the project file in a local directory structure on client computer 118, updates the usage data for the project file in usage data repository 123, and displays the retrieved latest version of the project file in an editor window (not shown) of user interface 133a. In an embodiment, in response to determining that the project file is locked by a second user in the group, collaboration program 132a displays file usage information window 220 in user interface 133a. In one exemplary embodiment, file usage information window 220 includes attributes of the second user. The attributes may include, for example, a name of the second user 222, a phone number of the second user 224, instant messaging status of the second user 226, the second user's editing status 228, and the like.

In addition, according to an of the embodiment of the present invention, file usage information window 220 includes a plurality of selectable user interface elements, such as “Wait in Queue” button 230, “Notify Editor” button 232, and “Edit Copy” button 234. In response to the first user pressing “Notify Editor” button 232, collaboration program 132a generates a notification message 202 indicating that the first user is waiting for the project file to become available for allocation. Notification message 202 may be, for example, an instant message, an email message, a newsgroup message, a chat room message, a message for a social networking site, or the like. Next, collaboration program 132a transmits notification 202 to collaboration program 132b on client computer 120 via messaging server 104. In response to receiving notification 202, collaboration program 132b presents notification 202 to the second user in user interface 133b. In an embodiment, collaboration program 132 presents notification 202 in an instant messaging session graphical window 212 within user interface 133b. In response to receiving notification 202, collaboration program 132b sends a response message 204 back to collaboration program 132a via messaging server 104. Response message 204 may indicate, for example, an estimate as to when the second user will finish editing the project file. In an embodiment, collaboration program 132b may receive text of response message 204 from the second user via user interface 133b. Similarly to notification 202, response message 204 may be an instant message, email message, newsgroup message, chat room message, message for a social networking site, or the like. In response to receiving response message 204, collaboration program 132a presents message 204 to the first user in, for example, instant messaging session graphical window 211. In an embodiment, after a time period in the estimate in response message 204 expires, collaboration program 132a may send an alert indicating that the second user has relinquished allocation of the file. In response to the first user receiving the alert, the first user can re-request allocation of the file.

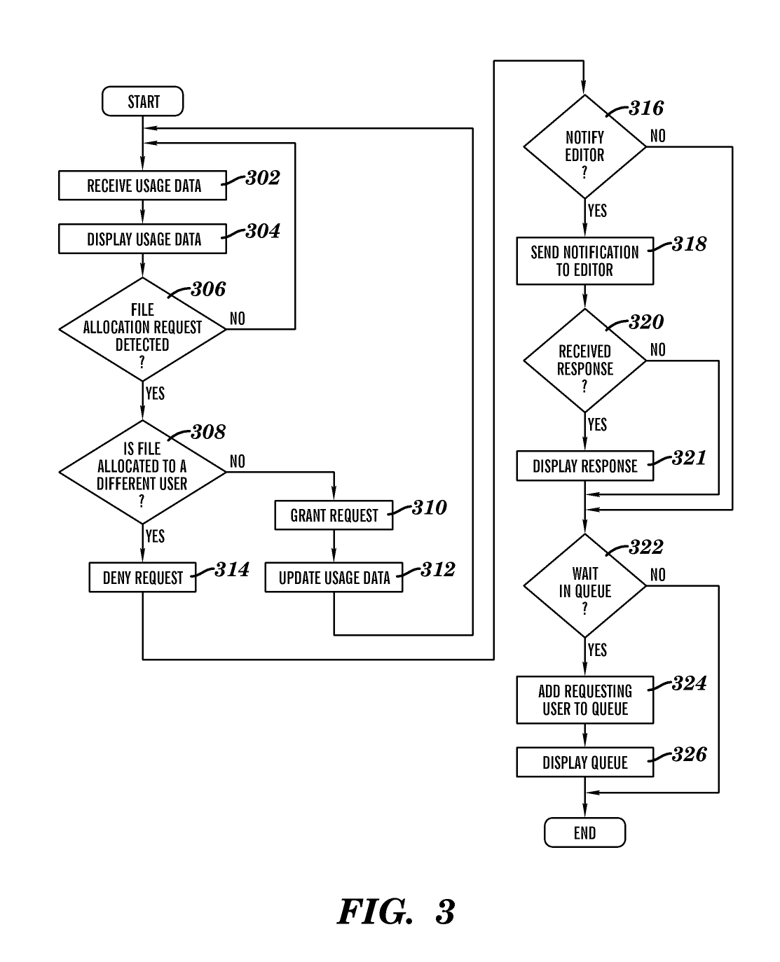

According to an embodiment, in response to the first user pressing “Wait In Queue” button 230, collaboration program 132a adds the first user to an end of a queue of one or more users in the group waiting for the second user to finish working with the project file. In an embodiment, collaboration program 132a displays a file waiting queue window 240 in user interface 133a. In various embodiments, waiting queue information for the project file may be included in usage data for the project file stored in usage data repository 123. Collaboration program 132a displays information in waiting queue window 240 that may include at least one attribute for each user waiting for the project file to become available for allocation, as shown in FIG. 2. In an embodiment, in response to the first user moving to the head of the waiting queue (the waiting queue is discussed below in conjunction with FIG. 3), collaboration program 132a may send an alert indicating to the first user indicating that the first user is at the head of the waiting queue. In response to the first user receiving the alert, the first user can re-request allocation of the file. In an embodiment, in response to another user relinquishing allocation of the file, collaboration program 132a may send an alert to the first user indicating that the file is available for allocation, if the first user is at the head of the waiting queue.

According to an embodiment, in response to the first user pressing “Edit Copy” button 234, collaboration program 132a retrieves a latest version of the project file from VCS code repository 124, stores the retrieved latest version of the project file into the local directory structure of client computer 118, and displays the retrieved latest version of project the file in user interface 133a, even though the project file is currently allocated to another user. It should be noted that, in an embodiment, VCS code repository 124 may allow multiple users to make a local copy of the project file and modify the project file independently, despite the project file being allocated to another user. However, VCS code repository 124 may need to merge these independent copies of the project file when they are checked back into VCS code repository 124 to synchronize changes. In an embodiment, collaboration program 132a updates the usage data to indicate that the first user may have made changes to the local copy of the file. Collaboration program 132a can display this particular usage data next to icon 205 (for example, as a different type of icon) in project window 208 to indicate that the first user has made a local copy of the file and to indicate that VCS code repository 124 may need to merge the first user's changes made in the local copy of the file at a later time.

Advantageously, various embodiments of the present invention enhance a software development environment by enabling users in the group to see which other users in the group are allocated which files. In addition, various embodiments of the present invention provide an opportunity for users in the group to communicate, from within the development environment, with other users in the group who have been allocated (and who may be editing) project files.

FIG. 3 illustrates in more detail the steps performed by a collaboration program for allocating a file to a user for editing, according to one embodiment of the present invention. At step 302, collaboration program 132a receives usage data for a file of a project. A support program, such as support program 135a of FIG. 1, may retrieve the usage data from usage data repository 123. In an embodiment, the usage data may include metadata that is associated with “usage” of the file by one or more users. The metadata may be described using eXtensible Markup Language (XML) format. In an embodiment, the metadata identifies a plurality of attributes for each file of the project (for example, file=<file name>, editor=<user 1's name>, image=<user 1's picture>, queue=<user 2's name, user 3's name, user 4' name>). At step 304, collaboration program 132a displays the received usage data in a user interface, e.g. user interface 133a of IDE client 130a. For example, collaboration program 132a may display the received usage data in a graphical window, such as project window 208 of FIG. 2. The usage data can include graphical icons, digital images, or the like, such as icons 205 and images 206 of FIG. 2.

In response to detecting an allocation request for the file from a first user at decision block 306 (yes branch), collaboration program 132a determines whether the file has been allocated to a second user (at decision block 308). In an embodiment, at block 306, collaboration program 132a detects the allocation request a monitoring the graphical window, such as project window 208 of FIG. 2. It should be understood that the first user may initiate the request by clicking on the name of the file within the graphical window. If at block 306, collaboration program 132a detects no allocation requests (decision block 306, no branch), collaboration program 132a returns to steps 302 and 304 where it continues to receive and display usage data. If at block 308, collaboration program 132a determines that the file has not been allocated to a second user (decision block 308, no branch), collaboration program 132a grants the first user's allocation request at step 310. In an embodiment, step 310 may include collaboration program 132a checking out a latest version of the file from a VCS code repository, such as VCS code repository 124 on server computer 106, and displaying the file in an editor window (not shown) of a user interface, e.g. user interface 133a of IDE client 130a. At step 312, collaboration program 132a updates the usage data for the file. In an embodiment, at step 312, collaboration program 132a notifies IDE server 140 of FIG. 1 that the first user is editing the displayed file. In response to receiving the notification, IDE server 140 updates the usage data for the file in accordance with data included in the notification (for example, the name of the file, the name of the first user, the telephone number of the first user, an instant messaging status of the first user, or the like). In response to completing step 312, collaboration program 132a returns to step 302.

In an embodiment, if at decision block 308, collaboration program 132a determines that the file is allocated to a second user (yes branch), collaboration program 132a denies the first user's allocation request at step 314. In an embodiment, step 314 may include collaboration program 132a displaying file usage information in a graphical window, for example, window 220 of FIG. 2. Thereafter, at decision block 316, collaboration program 132a determines whether the first user is interested in notifying the second user of the first user's interest in allocating the file to the first user. In an embodiment, collaboration program 132a can make this determination based on whether the first user has selected a selectable element in a user interface, such as “Wait in Queue” button 230 of FIG. 2, “Notify Editor” button 232 of FIG. 2, or “Edit Copy” button 234 of FIG. 2. If collaboration program 132a determines that the first user is interested in notifying the second user (decision block 316, yes branch), collaboration program 132a generates a notification, e.g. notification 202 of FIG. 2, and transmits the notification (at step 318) to collaboration program 132b. In an embodiment, message text of the notification may indicate that the first user is waiting for the file to become available for editing. In various embodiments, the notification, such as notification 202 of FIG. 2, comprises at least one of an IM message, an email message, an electronic message for a social networking site, and the like. It should be noted that collaboration program 132a may utilize the usage data for the file (for example, an <editor> metadata field) to determine an intended recipient for the notification.

At block 320, collaboration program 132a determines (at decision block 320) whether a response to the notification, such as response 204 of FIG. 2, has been received from collaboration program 132b. The response may include, for example, an estimate as to when the second user may finish editing the file. Similarly to the notification discussed above, in various embodiments, the response may comprises at least one of an IM message, an email message, an electronic message for a social networking site, and the like. If the determination is affirmative (decision block 320, yes branch), collaboration program 132a, at step 321, displays the received response to the first user in a user interface, such as user interface 133a of FIG. 1. However, if the determination is negative (decision block 320, no branch), collaboration program 132a proceeds to decision block 322. Similarly, if the determination of decision block 316 is negative (no branch), collaboration program 132a proceeds to decision block 322.

At decision block 322, collaboration program 132a determines whether or not the first user is interested in waiting for the file to become available. In an embodiment, collaboration program 132a can make this determination based on whether the first user selected a selectable element in a user interface, such as by pressing “Wait In Queue” button 230 of FIG. 2. If collaboration program 132a determines that the first user wishes to wait for the file to become available (decision block 322, yes branch), collaboration program 132a adds the first user to an end of a waiting queue, at step 324. In an embodiment of the present invention, IDE server 140 of FIG. 1 implements the waiting queue. In an embodiment, the waiting queue may be a first-in first-out (FIFO) queue for holding identifications of users while the users are waiting the file to become available for editing. Using a FIFO method, IDE server 140 moves the users sequentially through the waiting queue, from the end of the waiting queue to the head of the waiting queue. Illustratively, in response to the second user finishing editing the file, IDE server 140 allocates the file to a user waiting at the head of the waiting queue and removes that user from the waiting queue. In an embodiment, at step 324, collaboration program 132a sends a request to IDE server 140 of FIG. 1 to add the first user to the waiting queue. At step 326, collaboration program 132a displays data of the waiting queue in a window of IDE client 130a, such as window 240 of FIG. 2. Collaboration program 132a can receive, e.g., from IDE server 140, the data of the waiting queue in usage data for the file. In an embodiment, the data of the waiting queue can be included in a data field of the usage data. Of course, various changes and modifications to the illustrative embodiment described above will be apparent to those skilled in the art.

FIG. 4 is a block diagram of internal and external components of each of the computers of FIG. 1. Computers 106, 118 and 120 include respective sets of internal components 800a, b, c and external components 900a, b, c. Each of the sets of internal components 800a, b, c includes one or more processors 820, one or more computer-readable RAMs 822 and one or more computer-readable ROMs 824 on one or more buses 826, one or more guest operating systems 828 and one or more computer-readable tangible storage devices 830. The one or more operating systems 828 are stored on one or more of the computer-readable tangible storage devices 830 for execution by one or more of the processors 820 via one or more of the RAMs 822 (which typically include cache memory). Collaboration program 132a is stored on one or more of the computer-readable tangible storage devices 830 of internal components 800b for execution by one or more of the processors 820 of internal components 800b via one or more of the RAMs 822 of internal components 800b. Collaboration program 132b is stored on one or more of the computer-readable tangible storage devices 830 of internal components 800c for execution by one or more of the processors 820 of internal components 800c via one or more of the RAMs 822 of internal components 800c. In one embodiment, usage data repository 123 is also stored on one or more computer-readable tangible storage devices 830 of internal components 800a. In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b,c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Collaboration program 132a can be stored on one or more of the portable computer-readable tangible storage devices 936 of external components 900b, read via R/W drive or interface 832 of internal components 800b and loaded into one or more computer-readable tangible storage devices 830 of internal components 800b. Collaboration program 132b can be stored on one or more of the portable computer-readable tangible storage devices 936 of external components 900c, read via R/W drive or interface 832 of internal components 800c and loaded into one or more computer-readable tangible storage devices 830 of internal components 800c.

Each set of internal components 800a,b,c also includes a network adapter or interface 836 such as a TCP/IP adapter card. Collaboration programs 132a-b can be downloaded to client computers 118 and 120, respectively, from an external computer via a network (for example, the Internet, a local area network or other, wide area network) and network adapter or interface 836 of internal components 800b and 800c, respectively. From the network adapter or interface 836 of internal components 800b and 800c, collaboration programs 132a-b, respectively, are loaded into one or more computer-readable tangible storage devices 830 of internal components 800b and 800c, respectively. The network may comprise copper wires, optical fibers, wireless transmission, routers, firewalls, switches, gateway computers and/or edge servers.

Each of the sets of external components 900a,b,c includes a computer display monitor 920, a keyboard 930, and a computer mouse 934. Each set of internal components 800a,b,c also includes device drivers 840 to interface to computer display monitor 920, keyboard 930 and computer mouse 934. The device drivers 840, R/W drive or interface 832 and network adapter or interface 836 comprise hardware and software (stored in one or more computer-readable tangible storage devices 830 and/or one or more computer-readable ROMs 824).

Collaboration programs 132a-b can be written in various programming languages including low-level, high-level, object-oriented or non object-oriented languages. Alternatively, the functions of collaboration programs 132a-b can be implemented in whole or in part by computer circuits and other hardware (not shown).

The description above has been presented for illustration purposes only. It is not intended to be an exhaustive description of the possible embodiments. One of ordinary skill in the art will understand that other combinations and embodiments are possible.

What is claimed is:

1. A method for allocating a file to a user, the method comprising the steps of:
a first computer receiving, over a network, data monitored by a second computer, the first computer comprising an integrated development environment (IDE) client and the data comprising data of usage of the file by one or more users in a group of users;
the first computer receiving a request to allocate the file to a first user in the group;
in response to the first computer receiving the request, the first computer determining, based on the data of usage of the file, whether the file is allocated to a second user in the group;
in response to the first computer determining that the file is allocated to the second user in the group, the first computer denying the request;
the first computer adding the first user to an end of a queue identifying one or more users in the group that are waiting for the second user to relinquish allocation of the file; and
the first computer utilizing the data of usage of the file to display the queue in the IDE client.

2. The method of claim 1, further comprising the steps of:
after the step of denying the request, the first computer creating a copy of the file in a local directory structure of the first computer while the file is allocated to the second user; and
in response to the first computer creating the copy of the file in the local directory structure, the first computer displaying, in the IDE client, the data of usage of the file, wherein the data of usage of the file indicates an association between the first user and the copy of the file.

3. The method of claim 1, further comprising the step of the first computer displaying the data of usage of the file in the IDE client.

4. The method of claim 1, further comprising the steps of:
the first computer sending a notification to the second user indicating that the first user has requested an allocation of the file; and
after the step of the first computer sending the notification to the second user, the first computer receiving a message from the second user, the message including an estimate as to when the second user will relinquish allocation of the file.

5. The method of claim 4, wherein the notification and the message comprise at least one of an instant messaging (IM) message, an electronic mail (email) message, and an electronic message for a social networking site.

6. The method of claim 1, wherein the file comprises source code written in one or more computer languages.

7. The method of claim 4, wherein the data of usage of the file includes one or more user attributes, the one or more user attributes comprising at least one of a name of the second user, a digital image of the second user, contact information of the second user, an instant messaging status of the second user, and editing activity of the second user on the file.

8. A computer program product for allocating a file to a user, the computer program product comprising one or more computer-readable tangible storage devices and a plurality of program instructions stored on at least one of the one or more computer-readable tangible storage devices for execution by at least one of one or more processors, the plurality of program instructions comprising:
program instructions to receive, over a network, data monitored by a computer, the data comprising data of usage of the file by one or more users in a group of users;
program instructions to receive a request to allocate the file to a first user in the group;
program instructions to, in response to receiving the request, determine, based on the data of usage of the file, whether the file is allocated to a second user in the group;
program instructions to, in response to determining that the file is allocated to the second user in the group, deny the request;
program instructions to add the first user to an end of a queue identifying one or more users in the group that are waiting for the second user to relinquish allocation of the file;
program instructions to utilize the data of usage of the file to display the queue in an IDE client.

9. The computer program product of claim 8, the plurality of program instructions further comprising:
program instructions to create a copy of the file in a local directory structure while the file is allocated to the second user; and
program instructions to display, in the IDE client, the data of usage of the file, wherein the data of usage of the file indicates an association between the first user and the copy of the file.

10. The computer program product of claim 8, the plurality of program instructions further comprising:
program instructions to display the data of usage of the file in the IDE client.

11. The computer program product of claim 8, the plurality of program instructions further comprising:
program instructions to send a notification to the second user indicating that the first user has requested an allocation of the file; and
program instructions to receive a message from the second user, the message including an estimate as to when the second user will relinquish allocation of the file.

12. The computer program product of claim 11, wherein the notification and the message comprise at least one of an instant messaging (IM) message, an electronic mail (email) message, and an electronic message for a social networking site.

13. The computer program product of claim 8, wherein the file comprises source code written in one or more computer languages.

14. The computer program product of claim 8, wherein the data of usage of the file includes one or more user attributes, the one or more user attributes comprising at least one of a name of the second user, a digital image of the second user, contact information of the second user, an instant messaging status of the second user, and editing activity of the second user on the file.

15. A computer system for allocating a file to a user, the computer system comprising one or more processors, one or more computer-readable tangible storage devices, and a plurality of program instructions stored on at least one of the one or more storage devices for execution by at least one of the one or more processors, the plurality of program instructions comprising:
program instructions to receive, over a network, data monitored by a second computer system, the data comprising data of usage of the file by one or more users in a group of users;
program instructions to receive a request to allocate the file to a first user in the group;
program instructions to, in response to receiving the request, determine, based on the data of usage of the file, whether the file is allocated to a second user in the group;
program instructions to, in response to determining that the file is allocated to the second user in the group, deny the request;
program instructions to add the first user to an end of a queue identifying one or more users in the group that are waiting for the second user to relinquish allocation of the file;
program instructions to utilize the data of usage of the file to display the queue in an IDE client.

16. The computer system of claim 15, wherein the plurality of program instructions further comprise:
program instructions to display the data of usage of the file in the IDE client.

17. The computer system of claim 15, wherein the plurality of program instructions further comprise:
program instructions to send a notification to the second user indicating that the first user has requested an allocation of the file; and
program instructions to receive a message from the second user, the message including an estimate as to when the second user will relinquish allocation of the file.

18. The computer system of claim 17, wherein the notification and the message comprise at least one of an instant messaging (IM) message, an electronic mail (email) message, and an electronic message for a social networking site.

19. The computer system of claim 15, wherein the file comprises source code written in one or more computer languages.

20. The computer system of claim 15, wherein the data of usage of the file includes one or more user attributes, the one or more user attributes comprising at least one of a name of the second user, a digital image of the second user, contact information of the second user, an instant messaging status of the second user, and editing activity of the second user on the file.
